(19) United States
(12) Patent Application Publication
(10) Pub. No.: US 2007/0256844 A1
(43) Pub. Date: Nov. 8, 2007

(54) Method and apparatus for lock out-tag out of sprinkler heads

(76) Inventors: Joseph M. Blasing, Aurora, IL (US); Brent E. Sorrels, Dixon, IL (US)

Correspondence Address: George E. Bullwinkel, Bullwinkel Partners, Ltd., Suite 1300, 19 S LaSalle Street, Chicago, IL, 60603, US

(21) Appl. No.: 11/408,701

(22) Filed: Apr. 20, 2006

(51) Int. Cl. A62C 25/00

(52) U.S. Cl. 169/51; 239/288; 169/37

(57) ABSTRACT

A lockout device and method of operation for enclosing, protecting and inhibiting a heat-activated fire extinguisher sprinkler head in a workplace during construction and maintenance therein. The device has two hinged semi-cylindrical clamping elements which clamp on to the end of a sprinkler supply pipe without tools, and has two hinged shell portions defining a cavity for protectively enclosing the said sprinkler head. Captive bolts and thumbscrews provide hand operated securing means to hold the clamping means and shell portions together, and a padlock provides locking means to prevent unauthorized removal of the device. Visible indicia means are provided for informing persons in said workplace of the presence and purpose of the sprinkler head lockout devices. The method of use includes providing a highly visible lockout device for each sprinkler head in the workplace, locking and tagging each device with information including the purpose of the lockout, the persons responsible for the lockout, and the time when the sprinkler heads will be returned to normal operation. Alternate embodiments of the device permit actuation of the sprinkler heads while the device is in place by means of openings in the shell portions, or by constructing the shell portions of meltable material, which in either case will allow the entry of combustion products if the workplace fire is sufficiently intense.

### FIELD OF THE INVENTION

This invention relates to a safety device, namely, a lockout device for enclosing a fire protection sprinkler head in a workplace for preventing accidental damage and unauthorized access during construction and maintenance work therein, and its method of use.

More particularly, the invention relates to a removable protective cover for isolating a fire protection sprinkler head which can be locked and tagged following a protocol similar to that prescribed for control of hazardous energy by OSHA (Occupational Safety and Health) Regulations 29 CFR 1910.147 and 1926.416. The invention and its method of implementation ensures that sprinkler heads are not accidentally damaged during maintenance and construction operations, and provides assurances that they have been restored to full operational status after the work is completed.

### BACKGROUND OF THE INVENTION

OSHA Regulation 1910.159 sets standards for automatic sprinkler systems in workplaces. Each covered employer is required to assure that only approved equipment and devices are used in the design and installation of such automatic sprinkler systems, and also to maintain the systems in compliance with the appropriate regulations.

In particular, Regulation 1910.159(c)(8)(iii) specifies that “The employer shall assure that sprinklers are protected from mechanical damage.” Heat-activated sprinkler heads are typically quite fragile. Typically, they consist of a threaded end which is connected to a reliable pressurized source of water and a sprayer end defining an outlet enclosed by a cap or seal. A thermally responsive element such as a glass bulb or heat fusible element is engaged with the cap to maintain the cap in sealed position. To do its job, the thermally responsive element is necessarily exposed to the protected space, and is therefore vulnerable to inadvertent damage from the movement of building materials, positioning of ladders and the like. Thus the routine maintenance and sprinkler-protected spaces requires that all service personnel and skilled tradesmen such as carpenters and electricians take pains to assure that all sprinkler heads on or near the worksite are protected from breakage

Prior art efforts to protect sprinkler heads have included the provision of simple wire cages, as in U.S. Pat. No. 5,632,339 to Fenske, et al. (May 27, 1997), which while continuing to allow the head to function, provide little mechanical protection. Other devices such as U.S. Pat. No. 4,830,117 to Capasso (May 16, 1989) disclose a robust enclosure attachable by hand for terminating the flow from a runaway sprinkler, and for keeping it sealed afterwards—a questionable procedure in terms of fire safety.

The term “lock-out tag-out” refers to a specific method of servicing and maintenance of machines and equipment in which the unexpected energization or start up of the machines or equipment, or release of stored energy could cause injury to employees. (See OSHA standard 1910.147, Control of Hazardous Energy or Lock out/Tag out). This standard applies to the control of energy during servicing and/or maintenance of machines and equipment outside of normal operations, and applies, for example, to require the use of locks or tags at control points such as breaker boxes as warning devices to ensure that personnel are not injured from accidental machine start-ups.

Lock-out tag-out devices and methods have been described in prior art patents, but generally to protect against access to hazardous energy equipment and the like which are the subject of OSHA standard 1910.147, and but not for preventing damage to sprinkler system heads. For example, U.S. Pat. No. 5,149,429 to Herman et al. (Aug. 18, 1992) describes a lockable clamshell-type enclosure for an electrical connector attached to an electrical cable for preventing prevents access to the energized contacts while the device is in place. Pierced flanges or locking lugs are provided for the attachment of a padlock and/or identification tag.

Similar lock-out features are disclosed for pneumatic valves (U.S. Pat. No. 4,000,684 to Ruffley, Jan. 04, 1997) and for the attachment plug of an electrical appliance such as a television or power tool (U.S. Pat. No. 4,653,824 to Jason et al., Mar. 31, 1987, U.S. Pat. No. 4,957,445 to Burke, Jr., Sep. 18, 1990). A lock-out device using a padlock is disclosed in U.S. Pat. No. 6,205,827 to Lane (Mar. 27, 2001) for protecting against unauthorized adjustment of a purely mechanical torque isolator device.

The tag-out aspect of systems conforming to OSHA standard 1910.147 is addressed by publications US 2004/0030562 A1 to Williams (published Feb. 12, 2004) dealing with a business method applicable to public telecommunications. US 2004/0227631 A1 to Loudon (Nov. 18, 2004) discloses a generalized system incorporating a portable receiver and one or more clearly tagged radio transmitter “locks”, each including one or more switches, which are attachable to a device to be protected such as an electrical utility box. When the “lock” is disturbed, a signal is sent to sound an alarm in the receiver.

When applied to a sprinkler fire protection system, the term lock-out tag-out has a somewhat different significance. Instead of neutralizing potentially hazardous source of energy, as with an electrical terminal or element of rotating machinery, the locking out of a sprinkler head actually creates a potentially more dangerous situation in that a locked-out sprinkler head is disabled, or at least inhibited, from performing its intended role in extinguishing a fire. For this reason it is of particular importance that the lock-out function be accompanied by the tag-out function, whereby each disabled or inhibited sprinkler head can be positively identified by the workplace supervisor and returned to service when the construction or maintenance operations are completed for the day.

Another aspect of the conventional lock-out tag-out function of the prior art which does not apply to fire sprinkler protection systems is that with the latter, it is not intended that the fire protection function of the locked-out elements be completely inhibited, but only partially suppressed. In this way the system can be protected from inadvertent damage or activation (by a hot worklight, soldering torch, or the like), while still leaving it pressurized and ready to respond to a heat source (such as a serious fire) in which activation of the fire suppression function is required, even if somewhat delayed.

### SUMMARY OF THE INVENTION

Accordingly, an object of the present invention is to provide a lock-out tag-out device and method of operation which is employed to reliably protect the heat-activated sprinkler heads of a fire protection system from damage during maintenance and construction. A related object is to provide a degree of heat protection to prevent the sprinkler from being inadvertently activated by heat lamps, torches or the like which might be used nearby for construction or maintenance.

A further object is to provide such a device and method in which the lock-out device is lockable and thus not easily installed or removed except by authorized personnel, and which can be fitted with highly visible tag having indicia showing what person or contractor put it in place, and making it clear that it should not be removed except by authorized personnel.

Another object is to provide such a lock-out device which protects the sprinkler head, but does not totally inhibit its intended function, thus leaving it responsive to a serious overheating situation in which its fire suppression function is actually needed.

A still further object is to provide such a lock-out device which can be easily and cheaply manufactured by stamping or molding, and which can be quickly and easily installed and removed without the use of tools.

### A BRIEF DESCRIPTION OF THE DRAWINGS

In the drawings, FIG. 1 is a perspective view of a device embodying the present invention as installed placed on a fire sprinkler head;

FIG. 2 is a perspective view of the device of FIG. 1 in an open position, prior to installation;

FIG. 3 is a side elevation of the device of FIG. 1 in the installed position;

FIG. 4 is a cross-sectional elevation similar to FIG. 3; and

FIG. 5 is a side elevation of an alternative embodiment of the present invention incorporating a shell with openings which protects the sprinkler head while providing a limited degree of functionality.

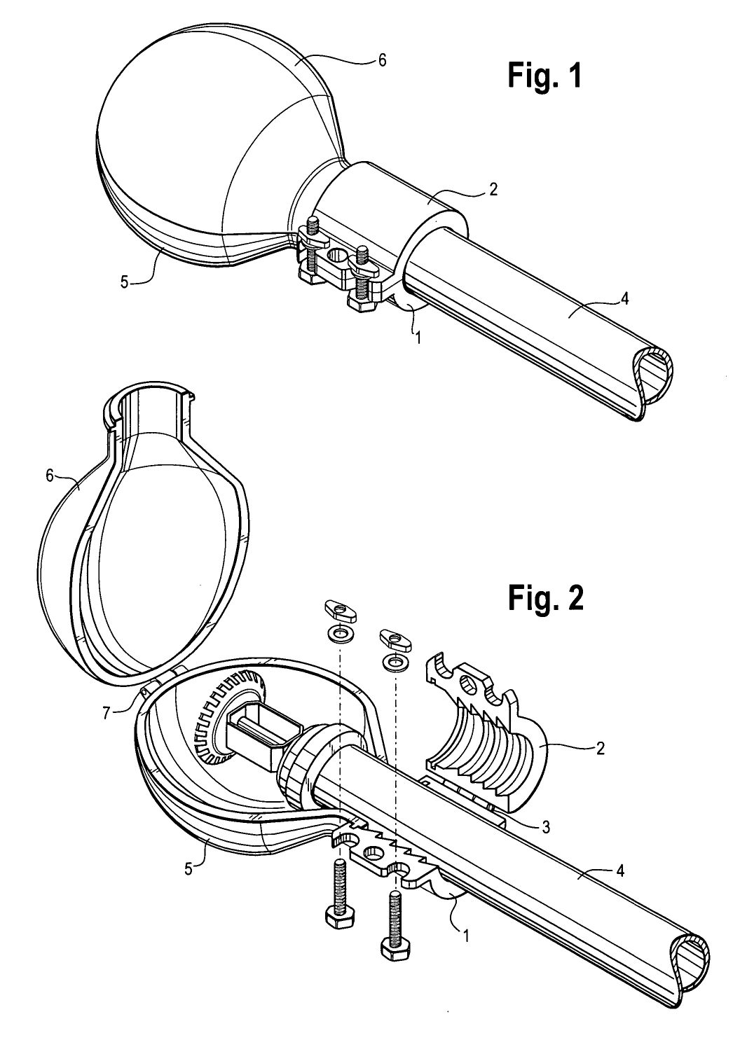

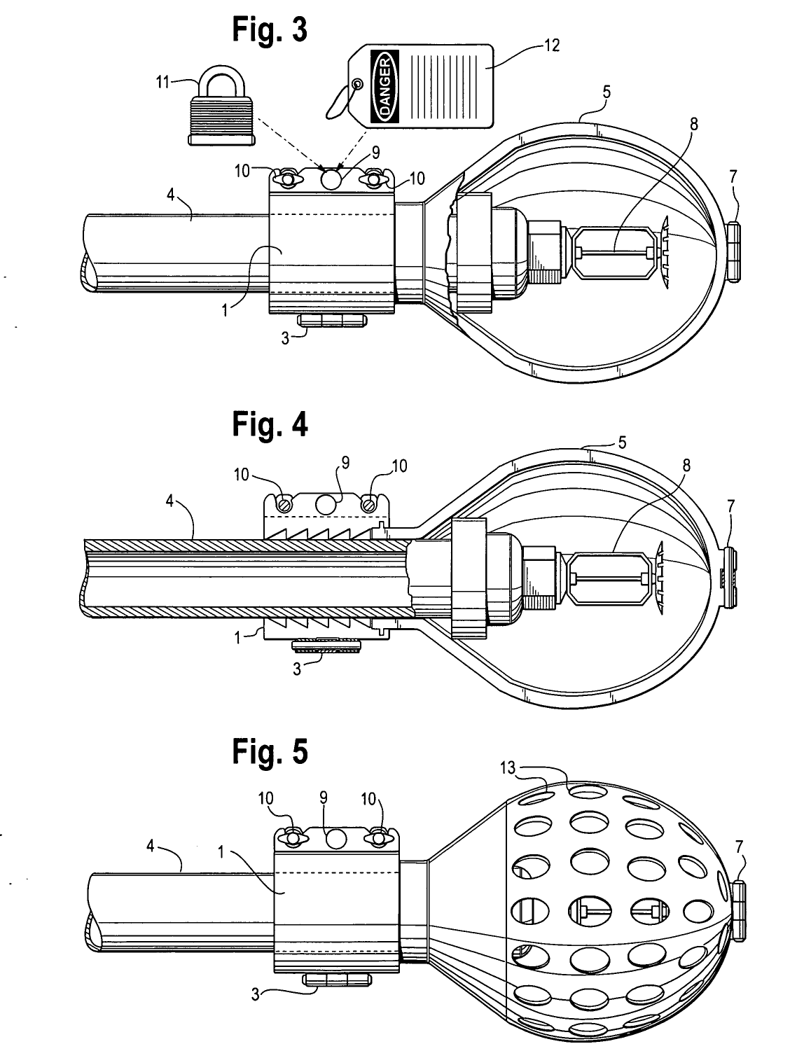

### DETAILED DESCRIPTION OF THE INVENTION

Turning to the drawings, There is shown in FIG. 1 a device embodying the present invention, open and ready to be attached to a fire extinguisher sprinkler head. One end of the device includes a clamping means consisting of first and second mating semi-cylindrical clamping elements 1, 2. Clamping element 2 is hinged to element 1 along a longitudinal axis by a hinge 3 at one side. This allows the clamping elements to be closed the end of a sprinkler system supply pipe 4 proximate to (just above the sprinkler) head to be protected. When closed and locked, clamping elements grip the pipe firmly in a clamping position, providing support to the rest of the device.

Below the clamping elements are first and second generally hemispherical shell portions 5, 6 defining a cavity for protectively enclosing the sprinkler head. The shell portions are hinged together at one end by a hinge 7 for opening and closing around the sprinkler head. The shell portions are preferably made large enough to provide sufficient clearance around the head itself for preventing unwanted transmission of shock or heat to the heat-actuated trigger element 8 of the sprinkler head.

For securing the clamping elements in place, the elements are provided with outwardly extending flanges 9 opposite the longitudinal clamping element hinge axis, and a manually actuated fastening means 10 for allowing a workman to attach said device without the use of tools. In the preferred embodiment the fastening means consists of a captive bolt in one flange which passes through a mating hole in the other flange and is secured by a thumbscrew or similar fastener.

Similarly, for securing the shell portions together, one shell portion 5 is fixed to one of the clamping elements 1, while the other shell portion 6 is provided with an outwardly extending flanges or collar opposite the shell hinge axis which fits into place beneath the hinged clamping element 2, and is thus secured by the same fastening means 10.

When closed, a removable locking means is provided, such as the illustrated keyed lock 11, which is can be attached to the clamping elements and to the shell portions to prevent inadvertent or unauthorized removal of the device before the scheduled maintenance or repair work has been completed.

As noted above, it is of particular importance that the lock-out function be accompanied by a tag-out function, whereby each disabled or inhibited sprinkler head can be positively identified by all workers in the area. The information preferably includes the purpose of the lock-out, the identity of the responsible workplace supervisor, and the time when the sprinklers will be returned to service. For this purpose, the device is preferably made in a highly visible color, and provision is made for attaching a tag 12 containing the desired information. In practice, before working in the subject work area, all sprinkler heads are protected with clearly visible lock-out devices according to the present invention, but without turning off pressure in the sprinkler head supply pipes. Each locked-out head is fitted with a lock and tag identifying the purpose of the lock-out, the responsible workplace supervisor, and the duration of the intended lock-out. At the end of the work shift, or the conclusion of the work, the locks and lock-out devices are removed, allowing the sprinkler heads to resume their normal functions.

In an alternate embodiment of the invention shown in FIG. 5, the shell portions are provided with openings 13 which permit each protected sprinkler head a limited degree of normal functionality, thus assuring that the workplace will not be without fire protection even while the work is being performed. The openings permit heat and hot combustion products to contact the sprinkler head, eventually actuating its heat-responsive trigger element and releasing a flow of extinguishing fluid which flows out through the same openings.

The device of the present invention is preferably made of lightweight cast metal, such as aluminum, but can also be made of a low-melting point alloy such as zinc or the like, or a meltable thermoplastic material, which in an actual fire situation will melt away, permitting the sprinkler head to be activated in its intended manner. Preferably, the melting point of the material constituting the shell portions is greater than the actuation temperature of the sprinkler head, but less than the kindling temperature of the surrounding workplace environment, thus assuring that even with the device in place, a sufficiently hot fire will still actuate the sprinkler system.

What is claimed is:

1. A lockout device for enclosing, protecting and inhibiting a heat-activated fire extinguisher sprinkler head in a workplace during construction and maintenance therein, said head being mounted at the termination of a pipe containing a source of pressurized fire extinguishing liquid, comprising
a) clamping means comprising first and second mating semi-cylindrical elements hinged together along a longitudinal axis for receiving and gripping said pipe proximate to said sprinkler valve,
b) first securing means for securing said clamping means in a closed position;
c) shell means comprising first and second shell portions defining a cavity for protectively enclosing said sprinkler head, said shell portions being hinged together for opening and closing around said sprinkler head,
d) second securing means for securing said shell portion in a closed position, and
e) visible indicia means for informing persons in said workplace of the presence and purpose of said lockout device.

2. A device according to claim 1 wherein said securing means includes a pair of outwardly extending mating flanges opposite said longitudinal axis and a manually actuated fastening means for allowing a workman to attach said device without the use of tools.

3. A device according to claim 2 wherein said of outwardly extending mating flanges further includes a locking device.

4. A device according to claim 3 in which said fastening means includes a captive bolt and thumbscrew, and said locking device includes a key-openable padlock.

5. A device according to claim 1 in which one of said shell portions has openings to permit the entry of combustion products and the exit of fire extinguishing liquid.

6. A device according to claim 1 in which said fire extinguisher sprinkler head has a predetermined actuation temperature, and said shell portions are constructed of a material having a melting point greater than said actuation temperature but less than the kindling temperature of the workplace environment.

7. A lock-out tag-out method of inhibiting and protecting a heat-activated fire extinguisher sprinkler head in a workplace during construction and maintenance work therein, said sprinkler head being mounted at the termination of a pipe containing a source of pressurized fire extinguishing liquid, comprising the steps of
a) providing a lockout device for enclosing, protecting and said sprinkler head, said lockout device comprising
i) clamping means comprising first and second mating semi-cylindrical elements hinged together along a longitudinal axis for receiving and gripping said pipe proximate to said sprinkler valve,
ii) first securing means for securing said clamping means in a closed position;
iii) shell means comprising first and second shell portions defining a cavity for protectively enclosing said sprinkler head, said shell portions being hinged together for opening and closing around said sprinkler head,
iv) second securing means for securing said shell means in a closed position,
v) locking means on said first and second securing means for preventing unauthorized access to said sprinkler head, and
vi) visible indicia means for informing persons in said workplace of the presence and purpose of said lockout device;
b) prior to the commencement of said work,
i) fitting each sprinkler head in said workplace with said lockout device,
ii) fitting each said lockout device with a lock for preventing unauthorized access, and
iii) fitting each said lockout device with visible indicia means for informing persons in said workplace of the presence and purpose of said lockout device,
c) performing said work, and
d) upon the conclusion of said work, removing each said lockout device to thereby return each said sprinkler head to normal operation.
